(19) United States
(12) Patent Application Publication
(10) Pub. No.: US 2009/0265350 A1
(43) Pub. Date: Oct. 22, 2009

(54) METHOD, SYSTEM AND KEY EXTRACTOR FOR CORRELATING ADVERTISEMENTS IN A VERTICAL SEARCH ENGINE

(75) Inventors: Yinyan TAN, Shenzhen (CN); Jieping ZHONG, Shenzhen (CN); Fangshan WANG, Shenzhen (CN); Qi FANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/492,257

(22) Filed: Jun. 26, 2009

Related U.S. Application Data
(63) Continuation of application No. PCT/CN2008/071360, filed on Jun. 19, 2008.

(30) Foreign Application Priority Data
Jun. 20, 2007 (CN) 200710111441.9

(51) Int. Cl. G06F 17/30

(52) U.S. Cl. 707/6; 707/E17.022

(57) ABSTRACT

An advertisement correlation method in a vertical search engine, a vertical search advertisement system, and a key extractor are disclosed. The method includes: receiving a search key input by a user; obtaining the search result information according to the search key; selecting correlation keys from the search result information; searching for the advertisements correlated with the correlation keys; and providing the correlated advertisement information.

### CROSS-REFERENCE TO RELATED APPLICATIONS

This application is a continuation of International Patent Application No. PCT/CN2008/071360, filed Jun. 19, 2008, which claims priority to Chinese Patent Application No. 200710111441.9, filed Jun. 20, 2007, both of which are hereby incorporated by reference in their entirety.

### FIELD OF THE INVENTION

The present invention relates to search engine technologies, and in particular, to an advertisement correlation method in a vertical search engine, a vertical search advertisement system, and a key extractor.

### BACKGROUND OF THE INVENTION

With the development and popularization of the Internet, information is exploding. To obtain pertinent contents from mass information, a search engine is indispensable. Because the information provided by a search engine is pertinent, an individual who searches for information through a search engine is usually a member of a group interested in a specific field. Therefore, for advertisers, launching advertisements to such potential customers is well-targeted and effective. Search engine advertisements have become online advertisements of the highest performance-to-price ratio.

Search engines are categorized into common search engines and vertical search engines.

A common search engine is generally based on the web page index database obtained by traversing the web space, and provides unstructured search results. A general working mode of a common search engine is: searching for the index of web pages that match the search key input by a user, and presenting the results in a certain order to the user on a results page. In the common search engine, the search key input by the user is generally a topic of the information to be looked up (such as news or essays), for example, “xx car”, and “xx magazine.” In the conventional art, an advertisement is launched in a common search engine by correlating the search key. When the search key input by the user matches the advertisement keyword purchased by an advertiser, the corresponding advertisement is displayed on the results page.

A vertical search engine is specific to an industry or an application field, and based on a structured web page database, provides structured or unstructured search results. A general working mode of a vertical search engine is: extracting structured information from web page information, namely, extracting the unstructured data of web pages into specific structured data, and then processing the data such as removing duplicates and classifying data. When the user inputs a search key, extracting the matched information from the structured database and returning the matched information to the user. In the vertical search engine, the search key input by the user is generally a restrictive condition. For example, in a vertical search engine, the search key input by the user may be an expected price such as “less than 500,000”, which is not a topic of the information desired by the user. In the conventional art, the launch of an advertisement in a vertical search engine is still similar to the launch in a common search engine, that is, the advertisement is launched by correlating the search keys.

In the process of researching and practicing the conventional art, the inventor finds that the advertisement correlation method in the vertical search engine in the conventional art has these defects: a vertical search engine has a definite application field and clear user groups, and is more suitable for launching advertisements than a common search engine. However, because the search key input by the user in the vertical search engine is not necessary a topic of the desired information, the method for launching advertisements based on search keys input by the user in the conventional art is not accurate, and impairs the effectiveness of advertisements drastically.

### SUMMARY OF THE INVENTION

Embodiments of the present invention provide an advertisement correlation method in a vertical search engine, a vertical search advertisement system, and a key extractor to improve accuracy of launching advertisements.

An advertisement correlation method in a vertical search engine provided in an embodiment of the present invention includes: receiving a search key input by a user; obtaining search result information according to the search key; selecting correlation keys in the search result information; and searching for advertisements correlated with the correlation keys; and providing correlated advertisement information.

A vertical search advertisement system provided in an embodiment of the present invention includes: a key extractor, adapted to select correlation keys in the search result information provided by a vertical search engine; and an advertisement service apparatus, adapted to search for the advertisements correlated with the correlation keys, and provide correlated advertisement information.

A key extractor provided in an embodiment of the present invention includes: (1) a result obtaining unit, adapted to obtain search result information provided by a vertical search engine, where the search result information is contents corresponding to several pieces of set metadata; (2) an extraction rule library, adapted to provide a key extraction rule, where the key extraction rule covers setting of candidate metadata and the candidate metadata covers part or all of the metadata in the search result information; and (3) an extracting unit, adapted to select correlation keys in the contents corresponding to the set candidate metadata in the search result information according to the key extraction rule.

In the embodiments of the present invention, an advertisement is correlated by selecting a key in the vertical search result information; the advertisement correlation is independent of the search key input by the user, and dynamic correlation is performed according to the search result. The result information includes the information which interests the user. Therefore, the advertiser can launch advertisements specific to contents, and launching advertisements are well-targeted and highly effective.

### BRIEF DESCRIPTION OF THE DRAWINGS

FIG. 1 is a flowchart of an advertisement correlation method in a vertical search engine according to embodiment A of the present invention;

FIG. 2 is a flowchart of an advertisement correlation method in a vertical search engine according to embodiment B of the present invention;

FIG. 3 shows a logical structure of a vertical search advertisement system according to embodiment C of the present invention; and

FIG. 4 shows a logical structure of a vertical search advertisement system according to embodiment D of the present invention.

### DETAILED DESCRIPTION OF THE INVENTION

An advertisement correlation method in a vertical search engine is provided in an embodiment of the present invention, where keys are selected in the vertical search result information to correlate advertisements. A vertical search advertisement system and a key extractor are also provided in an embodiment of the present invention. The method, system, and key extractor are detailed below.

### Embodiment A

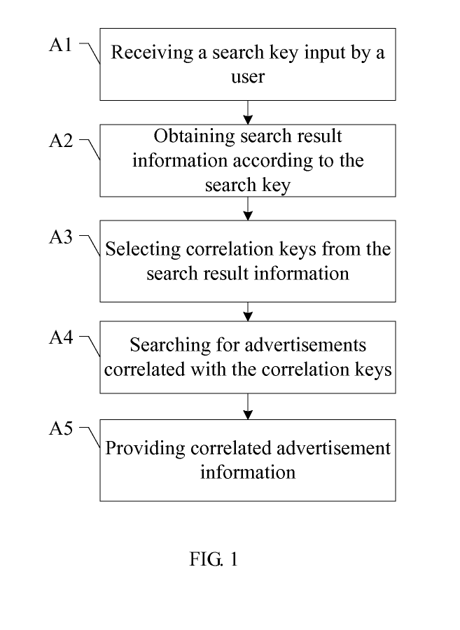

As shown in FIG. 1, an advertisement correlation method in a vertical search engine includes.

A1. Receiving a search key input by a user.

Before search, the user needs to determine what application field the search is about, for example, real estate, automobile, job, shopping or air ticket, and select the corresponding vertical search engine as according to the requirement of application. The search key input by the user is entered through a search entry provided by the vertical search engine. The search key may be a topic or restrictive condition of the information desired by the user. For example, if a user wants to search for real estate information, the search key may be “XX Road” or “property right longer than xx years.” If a user wants to search for job information, the search key may be “monthly pay xx” or “working place xx.”

A2. Obtaining search result information according to the search key.

The process of obtaining the detailed search result is similar to a search process in a general vertical search engine. Generally, through an information extraction and integration system, a vertical search engine organizes the web page information in a specific application scope in a structured way. A vertical search engine specific to an application field uses a specific structured data format to store the arranged web page information in a table. The structures whose information is extracted in a structured way or the elements of each part that are extracted are called “metadata” herein. In several common application fields, the types of metadata used by vertical search engines are exemplified in Table 1.

TABLE 1

| Application | |
|---|---|
| Field | Metadata Type |
| Real estate | Address, type, real estate type, price, opening time, title, |
| | and real estate company |
| Automobile | Brand, model, price, dealer, and telephone number |
| Air ticket | Takeoff airport and landing airport, flight number, takeoff |
| | time and landing time, plane model, bottom price, and |
| | airline company |

If the background data of the vertical search engine is organized and stored in a structured way according to the set metadata type, the contents corresponding to several pieces of set metadata may be obtained according to the search key in the process of search.

The field-specific information extracted by the vertical search engine from mass data may be provided for the user in a structured manner such as a data table; or provided for the user in an unstructured manner such as enumerating indexes of web pages carrying the search result information.

Specially, the search result information is empty, namely, no content that matches the search key input by the user is found. This circumstance is handled in general mode, and is not discussed herein.

A3. Selecting correlation keys from the search result information.

No matter whether the search key input by the user is a topic or restrictive condition of the expected information, the search result information carries the expected information. Therefore, by using the search result as a basis for selecting correlation keys, the pertinent results can be obtained.

Based on the structured characteristics of the information used in vertical search, an efficient and accurate key selection method is to select a key according to the metadata type. That is, the correlation key is selected from the contents corresponding to the set candidate metadata in the search result information, where the candidate metadata may be part or all of the metadata in the search result information.

The data table that provides the rule of selecting correlation keys from the search result is called “key extraction rule table” herein. Table 2 is a key extraction rule table that provides the candidate metadata setting mode.

TABLE 2

| Application | | Candidate |
|---|---|---|
| Field | Ignored Metadata | Metadata |
| Residence | Address, type, property type, price, and | Title, and real |
| | opening time | estate company |
| Automobile | Model, price, and telephone number | Brand, and |
| | | dealer |
| Air ticket | Takeoff airport and landing airport, | Airline company |
| | flight number, takeoff time and landing | |
| | time, plane model, and bottom price | |

All the metadata of the search results are divided into two parts in Table 2. “Candidate metadata” is a basis for selecting correlation keys. “Ignored metadata” is the data ignorable when selecting correlation keys. Table 2 shows that the metadata, which is not distinctive or pertinent as far as advertisement launch is concerned, may be incorporated into “ignored metadata.” The candidate metadata may be added or deleted by modifying the key extraction rule table. The process of selecting correlation keys from the candidate metadata may include the following steps:

1. Extracting the contents corresponding to the candidate metadata in the search result information as candidate keys; using all the contents corresponding to the candidate metadata in the search results as candidate keys.

2. Arranging the candidate keys into correlation keys, for example, combining the same candidate keys.

A4. Searching for the advertisements correlated with the correlation keys.

When launching an advertisement, the advertiser generally purchases one or more index keys for the advertisement. Accordingly, each index key may be correlated with one or more advertisements. The data table that provides the correlation between the index key and the advertisement is called “advertisement index table” herein. Table 3 is a typical example of advertisement index tables.

TABLE 3

| Index Key | Advertisement |
|---|---|
| Vanke Real Estate | n1, n2 |
| Shuanghuan Automobile Co., Ltd. | n3 |

In Table 3, n1-n3 are advertisement numbers. Through the advertisement number, the information related to the advertisement can be obtained from the stored advertisement library. The service provider of a vertical search engine may provide vertical search services of multiple application fields concurrently. To facilitate unified management of advertisement services, the index keys in different application fields may be put into the same advertisement index table. To increase the speed of matching the correlation keys with the index keys, the advertisement index table may also be stored separately for each specific application field.

In the process of searching for the advertisements correlated with the selected correlation keys, each correlation key may be matched with the index key in the advertisement index table directly (the detailed matching rule may be exact matching or fuzzy matching, the detailed matching rule is not limited herein). If the corresponding index key is matched, the correlation key is valid, and the correlated advertisements are available. Otherwise, the correlation key is invalid, namely, no corresponding advertisement is launched. To improve the efficiency of searching for advertisements, the following centralized matching method is also applicable:

1. Extracting the index keys in the advertisement index table into a collection of index keys, where the collection is relatively stable; when searching for the advertisements according to the correlation keys, performing a match operation for the collection of selected correlation keys and the collection of set index keys to obtain a collection of valid keys.

For example, if the collection of index keys is {ikey 1, ikey 2, . . . , ikey n} and the collection of correlation keys is {rkey 1, rkey 2, . . . , rkey m}, the obtained collection of valid keys is {ikey 1, ikey 2, . . . , ikey n}∩ {rkey 1, rkey 2, . . . , rkey m}.

2. Searching for the advertisements corresponding to each valid key in the obtained collection of valid keys.

A5. Providing correlated advertisement information.

After an advertisement is searched out, the contents such as pictures, texts, audios and size related to the advertisement may be obtained from the stored advertisement library, and provided in a proper manner, the details of which are similar to the general advertisement provision method. For example, the contents of the advertisement may be displayed on the search results page directly, or displayed through a pop-up advertisement page. The detailed display mode is not limited herein.

It is worthy of attention that if too many correlated advertisements are searched out in step A4, not all correlated advertisements are displayed finally. The extent of carrying advertisements at the time of providing search results for the user is called “advertisement capacity.” The advertisement capacity may be represented by the quantity of advertisements displayable on the search results page, or by the size of the area available for displaying advertisements, or by the quantity of advertisement windows allowed to pop up. When the quantity of found correlated advertisements exceeds the advertisement capacity, proper policies need to be applied so that a proper quantity of advertisements are selected. A common policy is bid ranking. The correlated advertisements are ranked in order of prices paid by the advertisers, and the higher priced advertisements are displayed first.

In the embodiments of the present invention, the advertisement is correlated by selecting a key in the vertical search result information; the advertisement correlation is independent of the search key input by the user, and dynamic correlation is performed according to the search result. The result information includes the information which interests the user. Therefore, the advertiser can launch advertisements specific to contents, and the advertisements are well-targeted and highly effective. Moreover, because vertical search provides structured result information, it is easier to delimit the selection scope of correlation keys through selection of the metadata. Therefore, the correlation keys can be collected more accurately and handled more quickly.

### Embodiment B

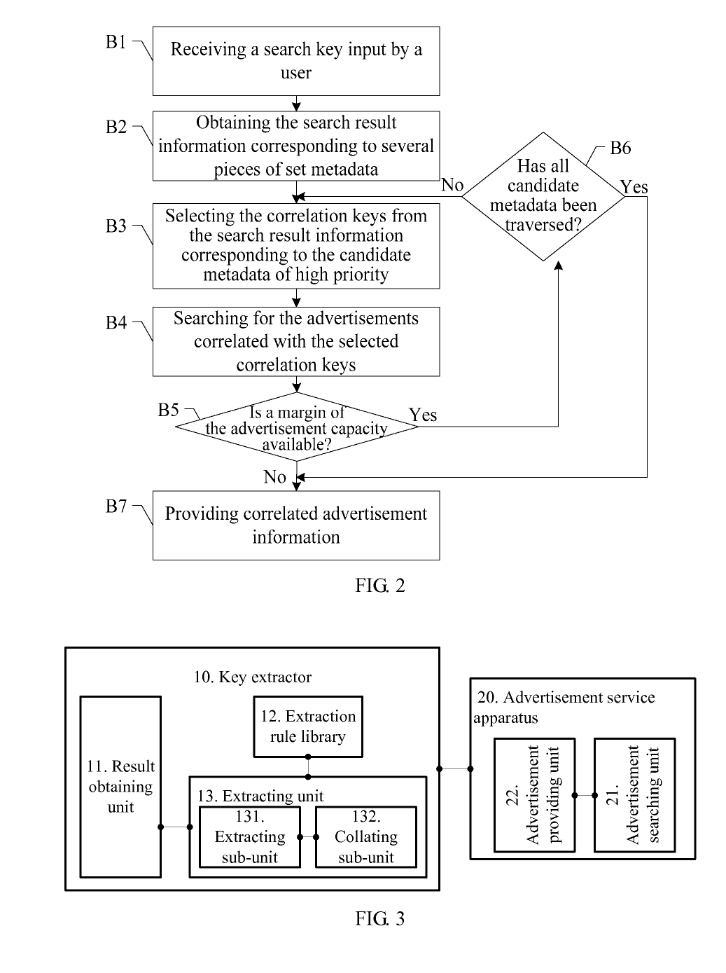

An advertisement correlation method in a vertical search engine is provided herein. This embodiment differs from embodiment A in that in the process of selecting correlation keys, the quantity of advertisements displayed is controlled according to the advertisement capacity. As shown in FIG. 2, the process includes the following.

B1. Receiving a search key input by a user.

B2. Obtaining the contents corresponding to the several pieces of set metadata according to the search key, and using such contents as search results.

The foregoing steps B1 and B2 can be performed with reference to steps A1 and A2 in embodiment A.

B3. Selecting the candidate metadata of high priority among the candidate metadata where no correlation key selection has been performed, and selecting correlation keys in the corresponding search result information.

In this embodiment, all metadata is arranged from the perspective of priority according to the “metadata weight.” Table 4 is a key extraction rule table that provides a metadata priority setting mode.

TABLE 4

| Application | | |
|---|---|---|
| Field | Metadata | Threshold |
| Residence | Real estate company (1) > Title (0.9) > Address | 0.8 |
| | (0.5) > type (0) = Real estate type (0) = Price (0) = | |
| | Opening time (0) | |
| Automobile | Dealer (1) > Brand (0.8) > Model (0.6) > Telephone | 0.8 |
| | number (0.2) > Price (0) | |
| Air ticket | Airline company (1) > Takeoff airport and Landing | 0.7 |
| | airport (0.5) > Flight number (0.3) > Plane model | |
| | (0) = Takeoff time and landing time (0) = | |
| | Bottom price (0) | |

In Table 4, the value in the brackets after the metadata is “metadata weight.” A higher metadata weight means a higher priority. A threshold of the “metadata weight” may be set to separate the candidate metadata from the ignored metadata. For example, if the threshold of the metadata weight in the automobile application field is 0.8, “dealer” and “brand” are candidate metadata. The sequence of selecting correlation keys is adjusted by modifying the metadata weight of the candidate metadata. The correlation keys can be selected from the contents corresponding to the selected candidate keys with reference to step A3 in embodiment A.

B4. Searching for the advertisements correlated with the selected correlation keys.

This step may be performed with reference to step A4 in embodiment A.

B5. Judging whether a margin of the advertisement capacity is available; if available, performing step B6. Otherwise, performing step B7.

B6. Judging whether all candidate metadata has been traversed. If not all candidate metadata has been traversed, performing step B3; if all candidate metadata has been traversed, performing step B7.

B7. Providing correlated advertisement information.

This step may be performed with reference to step A5 in embodiment A.

In the process of selecting correlation keys in this embodiment, the quantity of advertisements to be displayed is controlled according to the advertisement capacity. Therefore, incomplete display of advertisement information due to too many correlated advertisements is avoided when providing the correlated advertisement information; the time of selecting unnecessary correlation keys and the time of searching for the corresponding advertisements are saved; the process of handling the redundant advertisements subsequently is removed; and the implementation efficiency is improved.

It is understandable that the software for implementing the advertisement correlation method in the vertical search engine in the present invention may be stored in a computer-readable medium. When being executed, the software performs these steps: receiving a search key input by the user; obtaining the search result information according to the search key; selecting correlation keys from the search result information; searching for the advertisements correlated with the correlation keys; and providing the correlated advertisement information. The readable medium may be a Read-Only Memory or Random Access Memory (ROM/RAM), a magnetic disk or a compact disk.

To make the foregoing embodiment clearer, the processes of implementing embodiment A and embodiment B in specific scenarios are described below.

Scenario assumption: In the vertical search engine specific to automobile application, the search key input by the user is “priced over 500,000”, the metadata type is in a structure shown in Table 1, and the obtained search results are presented in a structured manner like Table 5.

TABLE 5

| | | | | Telephone |
|---|---|---|---|---|
| Brand | Model | Price | Dealer | Number |
| Audi | A84.2 | 1,250,000 | Marketing department of | 11111111 |
| | | | mycar168.com | |
| LIVINA | 1.6GSMT | 938,000 | Yupeng Automobile Sales | 22222222 |
| | super power | | Co., Ltd. | |
| Audi | A83.0 | 899,000 | Marketing department of | 11111111 |
| | extra long | | mycar168.com | |
| BMW 5 | 525Li | 655,500 | Baochuang Automobile | 33333333 |
| series | | | Company | |

The advertisement index table applied is shown in Table 6.

TABLE 6

| Index Key | Advertisement |
|---|---|
| Audi | 000001, 000004 |
| Marketing department of mycar168.com | 000005 |
| Shenzhen Zengte Audi | 000004 |
| Chuangguzhai Real Estate Development Co., Ltd. | 000002 |
| LIVINA | 000003 |

I. Advertisement correlation process in embodiment A

1. According to the key extraction rule table shown in Table 2, a decision is made about which correlation keys need to be selected from the search result contents corresponding to the candidate metadata “brand” and “dealer.” According to the search results in Table 5, the extracted candidate keys are “Audi, LIVINA, Audi, BMW 5 series, marketing department of mycar168.com, Yupeng Automobile Sales Co., Ltd., marketing department of mycar168.com, and Baochuang Automobile Company.”

2. The candidate keys are arranged into correlation keys “Audi, LIVINA, BMW 5 series, marketing department of mycar168.com, Yupeng Automobile Sales Co., Ltd., and Baochuang Automobile Company.”

3. The collection of correlation keys intersects the collection of the index keys in Table 6, and the intersection is a collection of valid keys “Audi, LIVINA, and marketing department of mycar168.com.”

4. According to the obtained collection of valid keys, the advertisement library is searched, and, as a result, the advertisements numbered 000001, 000003, 000004, and 000005 are the advertisements correlated with the automobile search results page.

II. Advertisement correlation process in embodiment B

1. The key extraction rule table shown in Table 4 is applied. If the threshold of the metadata weight is 0.8, “dealer (1)” and “brand (0.8)” are candidate metadata.

First, the correlation keys are selected from the search result contents corresponding to the “dealer (1)” of the highest priority. According to the search results in Table 5, the extracted candidate keys are “marketing department of mycar168.com, Yupeng Automobile Sales Co., Ltd., marketing department of mycar168.com, and Baochuang Automobile Company.”

2. The candidate keys are arranged into correlation keys “marketing department of mycar168.com, Yupeng Automobile Sales Co., Ltd., and Baochuang Automobile Company.”

3. The collection of correlation keys intersects the collection of the index keys in Table 6, and the intersection is a collection of valid keys “marketing department of mycar168.com.”

4. According to the obtained collection of valid keys, the advertisement library is searched, and, as a result, the advertisement numbered 000005 is the advertisement that needs to be correlated with the automobile search results page.

5. Supposing the advertisement capacity accommodates 5 advertisements in total and a margin of the advertisement capacity is available, the candidate metadata “brand (0.8)” of the next highest priority is processed. As in the foregoing process, the advertisements numbered 000001, 000003 and 000004 are the advertisements that need to be correlated with the automobile search results page.

6. After all candidate metadata (namely, the metadata with the weight threshold greater than or equal to 0.8) has been traversed, the advertisements numbered 000001, 000003, 000004 and 000005 are determined as the advertisements correlated with the automobile search results page.

The vertical search advertisement system provided in an embodiment of the present invention is detailed below.

### Embodiment C

As shown in FIG. 3, a vertical search advertisement system includes a key extractor 10 and an advertisement service apparatus 20.

The key extractor 10 is adapted to select a correlation key in the search result information provided by the vertical search engine. Based on the structured characteristics of the search results provided by the vertical search engine, the key extractor 10 may include: (1) a result obtaining unit 11, adapted to obtain search result information provided by the vertical search engine, where the search result information is contents corresponding to several pieces of set metadata; (2) an extraction rule library 12, adapted to provide a key extraction rule, where the key extraction rule covers setting of the candidate metadata and the candidate metadata covers part or all of the metadata in the search result information; and (3) an extracting unit 13, adapted to select correlation keys of the contents corresponding to the set candidate metadata in the search result information obtained by the result obtaining unit 11 according to the key extraction rule provided by the extraction rule library 12.

The extracting unit 13 may include: (1) an extracting sub-unit 131, adapted to extract the contents corresponding to the candidate metadata in the search result information and use such contents as candidate keys; and (2) a collating sub-unit 132, adapted to arrange the candidate keys extracted by the extracting sub-unit 131 into correlation keys, where the arrangement includes combining of the same candidate keys.

The advertisement service apparatus 20 adapted to search for the advertisements correlated with the correlation keys and provide correlated advertisement information. The advertisement service apparatus 20 may include: (1) an advertisement searching unit 21, adapted to perform a match operation for the collection of the correlation keys provided by the key extractor 10 and the collection of set index keys to obtain a collection of valid keys, and search for the advertisements corresponding to each valid key; and (2) an advertisement providing unit 22, adapted to provide the information about the advertisements found by the advertisement searching unit 21.

The vertical search advertisement system in this embodiment may be applied to execute the advertisement correlation method in a vertical search engine described in embodiment A.

### Embodiment D

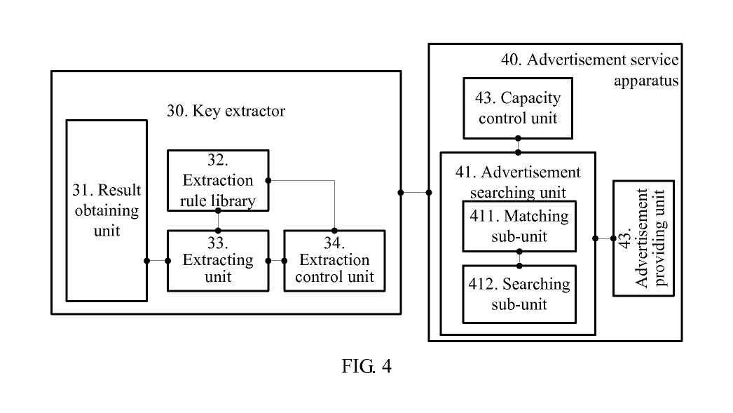

As shown in FIG. 4, a vertical search advertisement system includes a key extractor 30 and an advertisement service apparatus 40.

The key extractor 30 further includes: (1) a result obtaining unit 31, adapted to obtain search result information provided by the vertical search engine, where the search result information is contents corresponding to several pieces of set metadata; (2) an extraction rule library 32, adapted to provide a key extraction rule, where the key extraction rule covers setting of the candidate metadata and setting of the priority of the candidate metadata, and the candidate metadata covers part or all of the metadata in the search result information; (3) an extracting unit 33, adapted to select correlation keys of the contents corresponding to the candidate metadata specified by an extraction control unit 34 from the search result information obtained by the result obtaining unit 31 according to the key extraction rule provided by the extraction rule library 32; and (4) the extraction control unit 34, adapted to instruct the extracting unit 33 to select the correlation keys for the contents corresponding to the specified candidate metadata in descending order of priority according to the key extraction rule provided by the extraction rule library 32.

The advertisement service apparatus 40 further includes: an advertisement searching unit 41, adapted to search for the advertisements correlated with the correlation keys selected by the key extractor 30. It further includes: (1) a matching sub-unit 411, adapted to perform a match operation for the collection of correlation keys selected by the key extractor 30 and the collection of set index keys to obtain a collection of valid keys; (2) a searching sub-unit 412, adapted to search for the advertisements corresponding to each valid key obtained by the matching sub-unit 411; (3) an advertisement providing unit 42, adapted to provide the information about the advertisements found by the advertisement searching unit 41; and (4) a capacity control unit 43, adapted to judge whether a margin of the advertisement capacity is available after the advertisement searching unit 41 finishes an operation of searching for advertisements. If any margin of the advertisement capacity is available, instruct the extraction control unit 34 to continue specifying the candidate metadata.

The vertical search advertisement system in this embodiment may be applied to execute the advertisement correlation method in a vertical search engine described in embodiment B.

In embodiment C and embodiment D, the key extractor and the advertisement service apparatus may exist and apply as stand-alone devices respectively, or may be integrated into one device such as an advertisement server.

In the embodiments of the present invention, the advertisement is correlated by selecting a key in the vertical search result information. The advertisement correlation is independent of the search key input by the user, and dynamic correlation is performed according to the search result. The result information includes the information which interests the user. Therefore, the advertiser can launch advertisements specific to contents, and launching advertisements are well-targeted and highly effective. Moreover, because vertical search provides structured result information, which is easier to delimit the selection scope of correlation keys through selection of the metadata. Therefore, the correlation keys can be collected more accurately and handled more quickly. In the process of selecting correlation keys, the capacity of advertisements to be displayed may be controlled. Therefore, incomplete display of advertisement information due to too many correlated advertisements is avoided when providing the correlated advertisement information. The time of selecting unnecessary correlation keys and the time of searching for the corresponding advertisements are saved. The process of handling the redundant advertisements subsequently is removed; and the implementation efficiency is improved.

The above is a detailed description of an advertisement correlation method in a vertical search engine, the corresponding vertical search advertisement system, and a key extractor in several embodiments of the present invention. Although the invention has been described through some exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. An advertisement correlation method in a vertical search engine, comprising:
receiving a search key input by a user;
obtaining search result information according to the search key;
selecting a correlation key from the search result information;
searching for advertisements correlated with the correlation key; and
providing correlated advertisement information.

2. The advertisement correlation method of claim 1, wherein:
obtaining the search result information according to the search key comprises: obtaining contents corresponding to several pieces of set metadata according to the search key; and
selecting the correlation key from the search result information comprises: selecting the correlation key of the contents corresponding to a set candidate metadata from the search result information, wherein the candidate metadata comprises at least a portion of metadata in the search result information.

3. The advertisement correlation method of claim 2, wherein selecting the correlation key of the contents comprises:
extracting the contents corresponding to the candidate metadata in the search result information and using the contents as candidate keys; and
arranging the candidate keys into the correlation key.

4. The advertisement correlation method of claim 3, wherein arranging the candidate keys into the correlation key comprises:
combining candidate keys having identical key values into the correlation key.

5. The advertisement correlation method of claim 2, wherein: each piece of the candidate metadata corresponds to a set priority; and selecting the correlation key of the contents comprises:
selecting the correlation key from the contents corresponding to the candidate metadata of the highest priority; and
performing the follow steps until an advertisement capacity is completely consumed or all candidate metadata has been traversed:
searching for the advertisements correlated with the correlation key;
judging a margin of the advertisement capacity is available; and
selecting the correlation key from the contents corresponding to the candidate metadata of the next highest priority.

6. The advertisement correlation method of claim 1, wherein searching for the advertisements correlated with the correlation key comprises:
obtaining a collection of valid keys by matching a collection of the selected correlation keys for a collection of set index keys; and
searching for the advertisements corresponding to each valid key.

7. A vertical search advertisement system, comprising:
a key extractor, adapted to select a correlation key in search result information provided by a vertical search engine; and
an advertisement service apparatus, adapted to search for advertisements correlated with the correlation key, and provide correlated advertisement information.

8. The vertical search advertisement system of claim 7, wherein the key extractor comprises:
a result obtaining unit, adapted to obtain the search result information provided by the vertical search engine, wherein the search result information includes contents corresponding to several pieces of set metadata;
an extraction rule library, adapted to provide a key extraction rule, wherein the key extraction rule includes setting of candidate metadata having at least a portion of metadata in the search result information; and
an extracting unit, adapted to select the correlation key of the contents corresponding to the set candidate metadata in the search result information according to the key extraction rule.

9. The vertical search advertisement system of claim 8, wherein the extracting unit comprises:
an extracting sub-unit, adapted to extract the contents corresponding to the candidate metadata in the search result information and use the contents as candidate keys; and
a collating sub-unit, adapted to arrange the candidate keys into the correlation key.

10. The vertical search advertisement system of claim 9, wherein:
the collating sub-unit is adapted to combine candidate keys having identical key values into the correlation key.

11. The vertical search advertisement system of claim 8, wherein the key extraction rule provided by the extraction rule library further comprises settings of priorities of the candidate metadata;
the key extractor further comprises:
an extraction control unit, adapted to instruct the extracting unit to select the correlation key for the contents corresponding to the candidate metadata in a descending order of the priorities;
the advertisement service apparatus comprises:
an advertisement searching unit, adapted to search for the advertisements correlated with the correlation key selected by the extracting unit; and
a capacity control unit, adapted to judge a margin of an advertisement capacity is available and instruct the extraction control unit to specify the candidate metadata; and
an advertisement providing unit, adapted to provide information about the advertisements found by the advertisement searching unit.

12. The vertical search advertisement system of claim 11, wherein the advertisement searching unit comprises:
a matching sub-unit, adapted to match a collection of the correlation keys selected by the extracting unit to a collection of set index keys to obtain a collection of valid keys; and
a searching sub-unit, adapted to search for the advertisements corresponding to each valid key.

13. The vertical search advertisement system of claim 7, wherein the key extractor is integrated with the advertisement service apparatus.

14. A key extractor, comprising:
a result obtaining unit, adapted to obtain search result information provided by a vertical search engine, wherein the search result information includes contents corresponding to several pieces of set metadata;
an extraction rule library, adapted to provide a key extraction rule having setting of candidate metadata, the candidate metadata including at least a portion of metadata in the search result information; and
an extracting unit, adapted to select a correlation key of the contents corresponding to the set candidate metadata in the search result information according to the key extraction rule.

15. The key extractor of claim 14, comprising:
an extracting sub-unit, adapted to extract the contents corresponding to the candidate metadata in the search result information and use the contents as candidate keys; and
a collating sub-unit, adapted to arrange the candidate keys into the correlation key.

16. The key extractor of claim 14, wherein:
the key extraction rule provided by the extraction rule library further comprises settings of priorities of the candidate metadata; and
the key extractor further comprising:
an extraction control unit, adapted to instruct the extracting unit to select the correlation key for the contents corresponding to the candidate metadata in a descending order of the priorities.

17. The key extractor of claim 15, wherein the collating sub-unit further combines candidate keys having identical key values into the correlation key
